(19) United States
(12) Patent Application Publication
(10) Pub. No.: US 2007/0243773 A1
(43) Pub. Date: Oct. 18, 2007

(54) DYNAMIC MULTI-PURPOSE COMPOSITION FOR THE REMOVAL OF PHOTORESISTS AND METHOD FOR ITS USE

(76) Inventors: Michael T. Phenis, Markleville, IN (US); Raymond Chan, Carmel, IN (US); Kimberly Dona Pollard, Anderson, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/697,047

(22) Filed: Apr. 5, 2007

Related U.S. Application Data
(63) Continuation-in-part of application No. 11/551,826, filed on Oct. 23, 2006.
Application No. 11/551,826 is a continuation-in-part of application No. 11/260,912, filed on Oct. 28, 2005.

(51) Int. Cl. H01B 13/00; H01R 13/46

(52) U.S. Cl. 439/892; 216/16

(57) ABSTRACT

Improved dry stripper solutions for removing one, two or more photoresist layers from substrates are provided. The stripper solutions comprise dimethyl sulfoxide, a quaternary ammonium hydroxide, and an alkanolamine, an optional secondary solvent and less than about 3 wt. % water and/or a dryness coefficient of at least about 1. Methods for the preparation and use of the improved dry stripping solutions are additionally provided. Advantageous solution methods are provided for the use of the novel stripper solutions to prepare an electronic interconnect structure by removing a plurality of resist layers to expose an underlying dielectric and related substrate without imparting damage to any of the underlying structure.

This application is a continuation-in-part of application Ser. No. 11/551,826 filed on Oct. 23, 2006, which is a continuation-in-part of application Ser. No. 11/260,912, filed on Oct. 28, 2005, both of which are hereby incorporated by reference in their entirety.

The present disclosure relates generally to compositions having the ability to effectively remove photoresists from substrates and methods for their use. The compositions disclosed are stripper solutions for the removal of photoresists that have the ability to remain liquid at temperatures below normal room temperature and temperatures frequently encountered in transit and warehousing and additionally have advantageous loading capacities for the photoresist materials that are removed. Stripper solutions having reduced water content have proven particularly effective in cleanly removing photoresists, providing low copper etch rates, and increasing the solubility of photoresists in the stripper solution as evidenced by lower particle counts. Because of their ability to effectively and rapidly remove resist materials without damaging underlying dielectrics and the like, and maintain large amounts of removed resist material in solution, the new stripper solutions used in methods involving single and batch spray tool equipment, as well as in immersion processes have proven particularly useful in removing multi-layer resists encountered in preparing intact electronic interconnect structures.

### SUMMARY

In broad terms, a first aspect of the present disclosure provides for a photoresist stripper solution for effectively removing or stripping a photoresist from a substrate, having particularly high loading capacities for the resist material, and the ability to remain a liquid when subjected to temperatures below normal room temperature that are typically encountered in transit, warehousing and in use in some manufacturing facilities. The compositions according to this present disclosure typically remain liquid to temperatures as low as about −20° C. to about +15° C. The compositions according to the present disclosure typically contain dimethyl sulfoxide (DMSO), a quaternary ammonium hydroxide, and an alkanolamine. One preferred embodiment contains from about 20% to about 90% dimethyl sulfoxide, from about 1% to about 7% of a quaternary ammonium hydroxide, and from about 1% to about 75% of an alkanolamine having at least two carbon atoms, at least one amino substituent and at least one hydroxyl substituent, the amino and hydroxyl substituents attached to two different carbon atoms. The preferred quaternary groups are (C₁-C₈) alkyl, arylalkyl and combinations thereof. A particularly preferred quaternary ammonium hydroxide is tetramethyammonium hydroxide. Particularly preferred 1,2-alkanolamines include compounds of the formula: 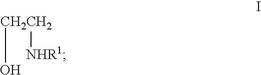
where R¹ can be H, C₁-C₄ alkyl, or C₁-C₄ alkylamino. For particularly preferred alkanol amines of formula I, R¹ is H or CH₂CH₂NH₂. A further embodiment according to this present disclosure contains an additional or secondary solvent. Preferred secondary solvents include glycols, glycol ethers and the like.

A second aspect of the present disclosure provides for methods of using the novel stripper solutions described above to remove photoresist and related polymeric materials from a substrate. A photoresist can be removed from a selected substrate having a photoresist thereon by contacting the substrate with a stripping solution for a time sufficient to remove the desired amount of photoresist, by removing the substrate from the stripping solution, rinsing the stripping solution from the substrate with a solvent and drying the substrate.

A third aspect of the present disclosure includes electronic devices manufactured by the novel method disclosed.

A fourth aspect of the present disclosure includes preferred stripper solutions containing dimethyl sulfoxide, a quaternary ammonium hydroxide, an alkanolamine, an optional secondary solvent with reduced amounts of water. The preferred solutions have a dryness coefficient of at least about 1 and more preferred solutions having a dryness coefficient of at least about 1.8, where the dryness coefficient (DC) is defined by the following equation:

$$DC = \frac{mass of base / mass of solution tested}{mass of water / mass of solution tested}$$

A fifth aspect of the present disclosure includes a method for removing a photoresist from a substrate with the new dry stripper solution. The method involves selecting a substrate having a photoresist deposited on it, contacting the substrate including the photoresist with a stripper solution that contains dimethyl sulfoxide, a quaternary ammonium hydroxide, an alkanolamine, an optional secondary solvent wherein the stripper solution has a dryness coefficient of at least about 1, removing the substrate from contact with the stripper solution and rinsing the stripper solution from the substrate.

A sixth aspect of the present disclosure includes an electronic device prepared in part by the method described above.

A seventh aspect of the present disclosure includes a method for providing a dry composition that includes dimethyl sulfoxide, a quaternary ammonium hydroxide, an alkanolamine, an optional secondary solvent wherein the solution has a dryness coefficient of at least about 1.

An eighth aspect of the present disclosure includes a method for obtaining a quaternary ammonium hydroxide having reduced water content by forming a solution of the quaternary ammonium hydroxide, unwanted water and a sacrificial solvent and subjecting the solution to reduced pressure with slight warming. During the treatment a portion of sacrificial solvent and water are removed. During the process excessive heating should be avoided to prevent decomposition of the hydroxide. The addition and removal of the sacrificial solvent with water can be repeated as necessary until the water content is sufficiently reduced.

A ninth aspect of the present disclosure includes a method for maintaining a low water content for a stripper solution. The method involves selecting a dry stripper solution, establishing contact between the stripper solution and molecular sieves, and maintaining contact with the sieves until the stripper solution is utilized. This method is particularly useful in maintaining the stripper solutions in a dry form following manufacture, during storage and/or shipping and after the solution's container has been opened.

A further aspect of the present disclosure includes a wet chemical method for preparing an electronic interconnect structure. Embodiments of the method include selecting a substrate having a plurality of resist layers and contacting the substrate with a stripper solution for a time sufficient to remove the plurality of resist layers. The method is particularly suited for substrates having at least three resist layers. Suitable stripper solutions comprise dimethyl sulfoxide, a quaternary ammonium hydroxide, and an alkanolamine having at least two carbon atoms, at least one amino substituent and at least one hydroxyl substituent, the amino and hydroxyl substituents attached to different carbon atoms. The term resist layers, as used herein, is intended to include anti-reflective layers (ARC) and bottom reflective layers (BARC) as well as other common resist materials.

### BRIEF DESCRIPTION OF THE DRAWINGS

FIG. 1a is top view of the wafer coated with a bilayer resist in Example 22 prior to cleaning.

FIG. 1b is top view of the wafer coated with a bilayer resist in Example 22 after cleaning.

FIG. 2a is cross-sectional view of the wafer coated with a bilayer resist in Example 22 prior to cleaning.

FIG. 2b is cross-sectional view of the wafer coated with a bilayer resist in Example 22 after cleaning.

FIG. 3a is a cross-sectional view of the wafer coated with a bilayer resist in Example 23 prior to cleaning.

FIG. 3b is a cross-sectional view of the wafer coated with a bilayer resist in Example 23 after cleaning.

FIG. 3c is a top view of the wafer coated with a bilayer resist in Example 23 after cleaning.

FIG. 3d is a cross-sectional view of the wafer coated with a bilayer resist in Example 23 after an extended cleaning time.

FIG. 3e is a surface view of the wafer coated with a bilayer resist in Example 23 after an extended cleaning time.

FIG. 4a is a cross-sectional view of the wafer coated with a trilayer resist in Example 24 prior to cleaning.

FIG. 4b is a cross-sectional view of the wafer coated with a trilayer resist in Example 24 after cleaning.

FIG. 5 is the Auger Electron Spectrum for the cleaned wafer from Example 24 after cleaning and sputtering for 0.6 of a minute to remove adventitious carbon.

FIG. 6 is a cross-sectional view of the wafer coated with an antireflection coating in Example 25 after cleaning.

FIG. 7 is a cross-sectional view of the wafer coated with an antireflection coating in Example 26 after cleaning.

FIG. 8a provides the FTIR spectra for a Thermal Oxide coating before and after long term exposure to the stripper solution in Example 28.

FIG. 8b provides the FTIR spectra for a CORAL® dielectric before and after long term exposure to the stripper solution in Example 28.

FIG. 8c provides the FTIR spectra for a BLACK DIAMOND® dielectric before and after long term exposure to the stripper solution in Example 28.

### DESCRIPTION

For the purposes of promoting an understanding of what is claimed, references will now be made to the embodiments illustrated and specific language will be used to describe the same. It will nevertheless be understood that no limitation of the scope of what is claimed is thereby intended, such alterations and further modifications and such further applications of the principles thereof as illustrated therein being contemplated as would normally occur to one skilled in the art to which the disclosure relates.

The compositions according to this present disclosure include dimethyl sulfoxide (DMSO), a quaternary ammonium hydroxide, and an alkanolamine. Preferred alkanol amines having at least two carbon atoms, at least one amino substituent and at least one hydroxyl substituent, the amino and hydroxyl substituents attached to two different carbon atoms. Preferred quaternary substituents include (C₁-C₈) alkyl, benzyl and combinations thereof. Preferred compositions have a freezing point of less than about −20° C. up to about +15° C. and a loading capacity of from about 15 cm³/liter up to about 90 cm³/liter. For the dry stripper solutions, preferred quaternary substituents include C₁-C₄ alkyl, arylalkyl or combinations thereof.

Formulations having increased levels of an alkanolamine are particularly noncorrosive to carbon steel are less injurious to typical waste treatments systems and auxiliary equipment than other stripper solutions. Particularly preferred compositions contain 1,2-alkanolamines having the formula: 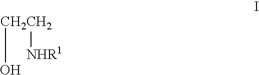
where R¹ is hydrogen, (C₁-C₄) alkyl, or (C₁-C₄) alkylamino. Some preferred formulations additionally contain a secondary solvent. Particularly preferred formulations contain from about 2% to about 75% of a secondary solvent. Particularly useful secondary solvents include glycols and their alkyl or aryl ethers described in more detail below. The preferred formulations have freezing points sufficiently below 25° C. to minimize solidification during transportation and warehousing. More preferred formulations have freezing points below about 15° C. Because the preferred stripper solutions remain liquid at low temperatures, the need to liquefy solidified drums of stripper solution received during cold weather or stored in unheated warehouses before the solution can be used is eliminated or minimized. The use of drum heaters to melt solidified stripper solution is time consuming, requires extra handling and can result in incomplete melting and modification of the melted solution's composition.

Additionally, compositions according to the present disclosure display high loading capacities enabling the composition to remove higher levels of photoresists without the precipitation of solids. The loading capacity is defined as the number of cm³ of photoresist or bilayer material that can be removed for each liter of stripper solution before material is re-deposited on the wafer or before residue remains on the wafer. For example, if 20 liters of a stripper solution can remove 300 cm³ of photoresist before either redepositon occurs or residue remains on the wafer, the loading capacity is 300 cm³/20 liters=15 cm³/liter

The compositions typically contain about 55% to about 95% solvent, all or most of which is DMSO and from about 2% to about 10% of the quaternary ammonium hydroxide. Preferred quaternary substituents include (C₁-C₈)alkyl, benzyl and combinations thereof. When used, a secondary solvent typically comprises from about 2% to about 35% of the composition. The stripping formulations can also contain an optional surfactant, typically at levels in the range of about 0.01% to about 3%. Suitable levels of the required alkanolamine can range from about 2% to about 75% of the composition. Because some of the stripper solution's components can be provided as aqueous solutions, the composition can optionally contain small amounts of water. All percents provided herein are weight percents.

Preferred alkanolamines have at least two carbon atoms and have the amino and hydroxyl substituents on different carbon atoms. Suitable alkanolamines include, but are not limited to, ethanolamine, N-methylethanolamine, N-ethylethanolamine, N-propylethanolamine, N-butylethanolamine, diethanolamine, triethanolamine, N-methyldiethanolamine, N-ethyldiethanolamine, isopropanolamine, diisopropanolamine, triisopropanolamine, N-methylisopropanolamine, N-ethylisopropanolamine, N-propylisopropanolamine, 2-aminopropane-1-ol, N-methyl-2-aminopropane-1-ol, N-ethyl-2-aminopropane-1-ol, 1-aminopropane-3-ol, N-methyl-1-aminopropane-3-ol, N-ethyl-1-aminopropane-3-ol, 1-aminobutane-2-ol, N-methyl-1-aminobutane-2-ol, N-ethyl-1-aminobutane-2-ol, 2-aminobutane-1-ol, N-methyl-2-aminobutane-1-ol, N-ethyl-2-aminobutane-1-ol, 3-aminobutane-1-ol, N-methyl-3-aminobutane-1-ol, N-ethyl-3-aminobutane-1-ol, 1-aminobutane-4-ol, N-methyl-1-aminobutane-4-ol, N-ethyl-1-aminobutane-4-ol, 1-amino-2-methylpropane-2-ol, 2-amino-2-methylpropane-1-ol, 1-aminopentane-4-ol, 2-amino-4-methylpentane-1-ol, 2-aminohexane-1-ol, 3-aminoheptane-4-ol, 1-aminooctane-2-ol, 5-aminooctane-4-ol, 1-aminopropane-2,3-diol, 2-aminopropane-1,3-diol, tris(oxymethyl)aminomethane, 1,2-diaminopropane-3-ol, 1,3-diaminopropane-2-ol, and 2-(2-aminoethoxy)ethanol.

Appropriate glycol ether solvents include, but are not limited to, ethylene glycol monomethyl ether, ethylene glycol monoethyl ether, ethylene glycol monobutyl ether, ethylene glycol dimethyl ether, ethylene glycol diethyl ether, diethylene glycol monomethyl ether, diethylene glycol monoethyl ether, diethylene glycol monopropyl ether, diethylene glycol monoisopropyl ether, diethylene glycol monobutyl ether, diethylene glycol monoisobutyl ether, diethylene glycol monobenzyl ether, diethylene glycol diethyl ether, triethylene glycol monomethyl ether, triethylene glycol dimethyl ether, polyethylene glycol monomethyl ether, diethylene glycol methyl ethyl ether, triethylene glycol, ethylene glycol monomethyl ether acetate, ethylene glycol monoethyl acetate, propylene glycol monomethyl ether, propylene glycol dimethyl ether, propylene glycol monobutyl ether, dipropyelene glycol monomethyl ether, dipropylene glycol monopropyl ether, dipropylene glycol monoisopropyl ether, dipropylene glycol monobutyl ether, dipropylene glycol dimethyl ether, dipropylene glycol dipropyl ether, dipropylene glycol diisopropyl ether, tripropylene glycol and tripropylene glycol monomethyl ether, 1-methoxy-2-butanol, 2-methoxy-1-butanol, 2-methoxy-2-methyl-2-butanol, 3-methoxy-3-methyl-1-butanol, dioxane, trioxane, 1,1-dimethoxyethane, tetrahydrofuran, crown ethers and the like.

The compositions can also optionally contain one or more corrosion inhibitors. Suitable corrosion inhibitors include, but are not limited to, aromatic hydroxyl compounds such as catechol; alkylcatechols such as methylcatechol, ethylcatechol and t-butylcatechol, phenols and pyrogallol; aromatic triazoles such as benzotriazole; alkylbenzotriazoles; carboxylic acids such as formic acid, acetic acid, propionic acid, butyric acid, isobutyric acid, oxalic acid, malonic acid, succinic acid, glutaric acid, maleic acid, fumaric acid, benzoic acid, phtahlic acid, 1,2,3-benzenetricarboxylic acid, glycolic acid, lactic acid, malic acid, citric acid, acetic anhydride, phthalic anhydride, maleic anhydride, succinic anhydride, salicylic acid, gallic acid, and gallic acid esters such as methyl gallate and propyl gallate; organic salts of carboxyl containing organic containing compounds described above, basic substances such as ethanolamine, trimethylamine, diethylamine and pyridines, such as 2-aminopyridine, and the like, and chelate compounds such as phosphoric acid-based chelate compounds including 1,2-propanediaminetetramethylene phosphonic acid and hydroxyethane phosphonic acid, carboxylic acid-based chelate compounds such as ethylenediaminetetraacetic acid and its sodium and ammonium salts, dihydroxyethylglycine and nitrilotriacetic acid, amine-based chelate compounds such as bipyridine, tetraphenylporphyrin and phenanthroline, and oxime-based chelate compounds such as dimethylglyoxime and diphenylglyoxime. A single corrosion inhibitor may be used or a combination of corrosion inhibitors may be used. Corrosion inhibitors have proven useful at levels ranging from about 1 ppm to about 10%.

Preferred optional surfactants have included fluorosurfactants. One example of a preferred fluorosurfactant is DuPont FSO (fluorinated telomere B monoether with polyethylene glycol (50%), ethylene glycol (25%), 1,4-dioxane (<0.1%), water 25%).

Preferred temperatures of at least 50° C. are preferred for contacting the substrate whereas for a majority of applications, temperatures of from about 50° C. to about 85° C. are more preferred. The major limitations on the upper temperatures utilized include the stability of the quaternary ammonium hydroxide at the upper temperatures and the volatility of the solvent or solvents included. For particular applications where the substrate is either sensitive or longer removal times are required, lower contacting temperatures are appropriate. For example, when reworking substrates, it may be appropriate to maintain the stripper solution at a temperature of at least 20° C. for a longer time to remove the photoresist and avoid damaging to the substrate. If longer contact times are required for complete resist removal, contacting the substrate with the stripper solution under a blanket of dry nitrogen can reduce water uptake from the atmosphere and maintain the dry stripper solution's improved performance.

When immersing a substrate, agitation of the composition additionally facilitates photoresist removal. Agitation can be effected by mechanical stirring, circulating, or by bubbling an inert gas through the composition. Upon removal of the desired amount of photoresist, the substrate is removed from contact with the stripper solution and rinsed with water or an alcohol. DI water is a preferred form of water and isopropanol is a preferred alcohol. For substrates having components subject to oxidation, rinsing is preferably done under an inert atmosphere. The preferred stripper solutions according to the present disclosure have improved loading capacities for photoresist materials compared to current commercial products and are able to process a larger number of substrates with a given volume of stripper solution.

The stripper solutions provided in this disclosure can be used to remove polymeric resist materials present in a single layer or certain types of bilayer resists. For example, bilayer resists typically have either a first inorganic layer covered by a second polymeric layer or can have two polymeric layers. Utilizing the methods taught below, a single layer of polymeric resist can be effectively removed from a standard wafer having a single polymer layer. The same methods can also be used to remove a single polymer layer from a wafer having a bilayer composed of a first inorganic layer and a second or outer polymer layer. Finally, two polymer layers can be effectively removed from a wafer having a bilayer composed of two polymeric layers. The new dry stripper solutions can be used to remove one, two or more resist layers.

The preferred dry stripper solutions contain dimethyl sulfoxide, a quaternary ammonium hydroxide, an alkanolamine, an optional secondary solvent and less than about 3 wt. % of water. Preferred secondary solvents are glycol ethers. More preferred dry stripper solutions contain dimethyl sulfoxide, a quaternary ammonium hydroxide, an alkanolamine, a glycol ether solvent and a dryness coefficient of at least about 1.8

Use of the dry photoresist stripper solution is similar to that described above for stripper solutions having a low freezing point. However, it is helpful to maintain the stripper solution in a dry form prior to use and to minimize water uptake during its use by maintaining a generally dry environment in the area involved with resist removal. Stripper solutions can be maintained in a dry state by maintaining contact between the stripper solution and active molecular sieves during storage, transit and after opening a container prior to its use.

The dry stripper solutions described herein should be prepared from dry components to the extent possible. Because quaternary ammonium hydroxides are hygroscopic and are generally available as aqueous solutions or their hydrates, water contained in the solution or associated with the hydrate must generally be removed to provide a dry stripper solution having a dryness coefficient of at least about 1. Efforts to dry quaternary ammonium hydroxides at elevated temperatures and to a dry state generally results in decomposition of the hydroxide. It has surprisingly been found that quaternary ammonium hydroxides in a volatile solvent can be pre-dried to give a solvent wet paste having reduced water content without decomposition. A dry stripper solution containing a quaternary ammonium hydroxide can be prepared by pre-drying the quaternary ammonium hydroxide and combining it with other substantially dry components to maintain a low water content or by subsequently drying an initially formed wet stripper solution formed from water-containing components.

A pre-dried form of a quaternary ammonium hydroxide can be obtained by subjecting a hydrated or otherwise wet form of a quaternary ammonium hydroxide to a reduced pressure with very slight warming. Water removal may be facilitated by dissolving the quaternary ammonium hydroxide in a solvent such as an alcohol prior to subjecting the hydroxide to reduced pressure. Based on work carried out thus far, a preferred alcohol is methanol. During this treatment a substantial portion of the water and alcohol are removed to provide an alcohol wet paste of the quaternary ammonium hydroxide. Depending on the level of dryness desired, additional dry alcohol can be added to the initially treated hydroxide and the treatment at reduced pressure repeated one or more times. Treatments can be carried out at pressures of from about 0.001 to about 30 mmhg and at temperatures of up to at least about 35° C. without substantial decomposition of the quaternary ammonium hydroxide. More preferred treatments can be carried out at pressures of from about 0.01 to about 10 mmhg.

For wet formulations with or without a secondary solvent, drying can be carried out on the stripper solution after the addition of all components by contacting the stripper solution with a solid drying agent, such as for example, molecular sieves, calcium hydride, calcium sulfate or a combination of drying agents. A preferred drying agent is an activated 3A or 4A molecular sieve. For dry stripper solutions containing a secondary solvent, it is preferred to combine the quaternary ammonium hydroxide (and any other wet components), contact the resulting solution with an active drying agent such as molecular sieves, separate the dry solution from the spent drying agent and add any remaining dry components to the dry solution. Contact with the molecular sieves or other solid drying agent can be by any known method, such as slurrying the solution with drying agent and filtering the dry slurry. Similarly, any of the wet solutions described above can be dried by passing the wet solution through pelletized activated molecular sieves or other drying agent in a column. Suitable molecular sieves include type 3A, 4A and 5A sieves.

Molecular sieves are also a preferred drying agent or desiccant to maintain the stripper solution in a dry state. The pellet form is most preferred because it allows removal of the dry stripper solution by simple decantation. However, for applications in which decantation does not provide an adequate separation, molecular sieve, whether powder or pellets can be incorporated into a “tea bag” arrangement that will allow equilibrium with the solution, but not allow any sieve particles to contaminate the solution. Dry stripper solutions containing molecular sieves can be maintained in a dry state for extended periods of time after a container has been opened, depending on the amount of molecular sieves included with the stripper solution, the surrounding humidity and the amount of time the container is open.

Because the novel stripper solutions disclosed herein are particularly effective agents for the complete removal of multiple layers of resist materials, but gentle on substrates composed of dielectric materials and the like, and have the ability to retain very large amounts of dissolved resist materials in solution, the novel solutions are particularly useful for the removal of multi-layers of resists using spray tool equipment without causing damage to the underlying substrates. The use of the novel stripper solution with single or batch spray tool equipment provides complete resist removal and can provide greater through-put without damage to underlying substrates. Because immersion processes typically clean large numbers of coated wafers at one time, a mistake as to cleaning time with stripper solutions capable of attacking the substrate can lead to substantial monetary losses. The utilization of methods involving spray tool equipment and stripper solutions of the type disclosed herein which are capable of rapidly cleaning without damaging wafer substrates further enhances the advantages provided by methods utilizing spray tool equipment.

Although spray tool equipment generally refers to the delivery of a stripper solution as a spray, typical equipment may deliver a robust or only a modest stream of stripper solution. As used herein, the term “spraying” refers to the delivery of a stream of a liquid stripper to the surface of the substrate undergoing cleaning, regardless of the stream's velocity, its spray pattern, the size of its liquid droplets and the like.

In the examples which follow, novel stripper solutions are provided having the advantages described above along with methods for their use to prepare an electronic interconnect structure. Although all of the stripper solutions disclosed provide the advantages described herein, stripper solutions having low water content generally provide even more effective cleaning and greater resist solubility and are particularly advantageous for use in the spray tool equipment.

### EXAMPLES 1-13

The reactants listed in Table I were separately combined with stirring to give each of the 13 homogeneous stripper solutions. The freezing points were determined and are also provided in Table I. The compositions of Examples 1-13 can optionally be formulated without a surfactant and formulated to include a corrosion inhibitor.

TABLE I

| | | Freezing | Dryness |
|---|---|---|---|
| Exam- | | Point, | Coef- |
| ple | Formulation* | ° C. | ficient |
| 1 | 85.8 g DMSO (85.8%) | +13.2 | 1 |
| | 6.0 g Diethyleneglycol monomethyl | | |
| | ether (6.0%) | | |
| | 2.7 g Aminoethylethanolamine (2.7%) | | |
| | 2.75 g Tetramethylammonium hydroxide | | |
| | (2.75%) | | |
| | 2.75 g water (2.75%) | | |
| 2 | 61 g DMSO (61%) | −2.5 | 1 |
| | 35 g Monoethanolamine (35%) | | |
| | 2 g Tetramethylammonium hydroxide | | |
| | (2%) | | |
| | 2 g water (2%) | | |
| 3 | 51.5 g DMSO (51.5%) | −7.4 | 1 |
| | 35 g Diethylene glycol monomethyl | | |
| | ether (35%) | | |
| | 11.3 g Aminoethylethanolamine (11.3%) | | |
| | 1.1. g Tetramethylammonium hydroxide | | |
| | (1.1%) | | |
| | 1.1 g water (1.1%) | | |
| 4 | 71 g DMSO (71%) | +5.3 | 1 |
| | 27.4 g Monoethanolamine (27.4%) | | |
| | 0.8 g Tetramethylammonium hydroxide | | |
| | (0.8%) | | |
| | 0.8 g water (0.8%) | | |
| 5 | 27.4 g DMSO (27.4%) | +0.4 | 1 |
| | 71 g Monoethanolamine (71%) | | |
| | 0.8 g Tetramethylammonium hydroxide | | |
| | (0.8%) | | |
| | 0.8 g water (0.8%) | | |
| 6 | 86 g DMSO (86.4%) | +7.7 | 0.7 |
| | 6 g Diethylene glycol monomethyl | | |
| | ether (6%) | | |
| | 2.7 g Aminoethylethanolamine (2.7%) | | |
| | 2 g Benzyltrimethylammonium hydroxide | | |
| | (2%) | | |
| | 3 g water (3%) | | |
| 7 | 86 g DMSO (82.1%) | −4.6 | 0.25 |
| | 6 g Diethylene glycol monomethyl | | |
| | ether (5.7%) | | |
| | 2.7 g Aminoethylethanolamine (2.6%) | | |
| | 2 g Diethyldimethylammonium hydroxide | | |
| | (1.9%) | | |
| | 8 g water (7.7%) | | |
| 8 | 86 g DMSO (82.1%) | −5.5 | 0.25 |
| | 6 g Diethylene glycol monomethyl | | |
| | ether (5.7%) | | |
| | 2.7 Aminoethylethanolamine (2.6%) | | |
| | 2 g Methyltriethylammonium hydroxide | | |
| | (1.9%) | | |
| | 8 g water (7.7%) | | |
| 9 | 86 g DMSO (87.5%) | +8.4 | 0.8 |
| | 6 g Diethylene glycol monomethyl | | |
| | ether (6.1%) | | |
| | 2.7 g Aminoethylethanolamine (2.8%) | | |
| | 1.6 g Tetrabutylammonium hydroxide | | |
| | (1.6%) | | |
| | 2 g water (2%) | | |
| 10 | 63 g DMSO (61.2%) | −6.3 | 0.7 |
| | 35 g Monoethanolamine (34%) | | |
| | 2 g Benzyltrimethylammonium hydroxide | | |
| | (1.9%) | | |
| | 3 g water (2.9%) | | |
| 11 | 63 g DMSO (58.3%) | <−20 | 0.25 |
| | 35 g Monoethanolamine (32.4%) | | |
| | 2 g Diethyldimethylammonium hydroxide | | |
| | (1.9%) | | |
| | 8 g water (7.4%) | | |
| 12 | 63 g DMSO (58.3%) | <−20 | 0.25 |
| | 35 g Monoethanolamine (32.4%) | | |
| | 2 g Methyltriethylammonium hydroxide | | |
| | (1.9%) | | |
| | 8 g water (7.4%) | | |
| 13 | 63 g DMSO (62.0%) | −6.2 | 0.8 |
| | 35 g Monoethanolamine (34.4%) | | |
| | 1.6 g Tetrabutylammonium hydroxide | | |
| | (1.6%) | | |
| | 2 g water (2%) | | |

*Each formulation additionally contained an optional 0.03 g of DuPont FSO (fluorinated telomere B monoether with polyethylene glycol (50%), ethylene glycol (25%), 1,4-dioxane (<0.1%), water 25%)

### EXAMPLE 14

A silicon wafer having a photoresist thereon is immersed in the stripping solution from Example 1, maintained at a temperature of about 70° C. with stirring for from about 30 to about 60 minutes. The wafer is removed, rinsed with DI water and dried. Examination of the wafer will demonstrate removal of substantially all of the photoresist. For some applications, superior results may be obtained by immersing the wafer in the stripping solution without stirring and/or immersing the wafer for up to 150 minutes. The preferred manner of removing the photoresist from a wafer can readily be determined without undue experimentation. This method can be used to remove a single layer of polymeric photoresist or two polymeric layers present in bilayer resists having two polymer layers.

### EXAMPLE 15

A silicon wafer having a photoresist thereon is mounted in a standard spray device and sprayed with the stripper solution from Example 2, maintained at about 50° C. The spraying can optionally be carried out under an inert atmosphere or optionally in the presence of an active gas such as, for example, oxygen, fluorine or silane. The wafer can be removed periodically and inspected to determine when sufficient photoresist has been removed. When sufficient photoresist has been removed, the wafer can be rinsed with isopropanol and dried. This method can be used to remove a single layer of polymeric photoresist or two polymeric layers present in bilayer resists having two polymer layers.

The methods described in Examples 14 and 15 can be used with the stripper solutions of this disclosure to remove photoresists from wafers constructed of a variety of materials, including GaAs. Additionally, both positive and negative resists can be removed by both of these methods.

The methods described in Examples 14, 15 and 16 can similarly be used with the dry stripper solution described herein.

### EXAMPLE 16

The method described in Example 14 was used to remove photoresist from the wafers described below in Table II. Twenty liter volumes of three stripper solutions were used until either a residue of photoresist polymer remained on the wafer or until re-deposition of the polymer or its degradation products onto the wafer occurred, at which point the solutions loading capacity was reached. With this method the loading capacity was determined for the two stripper solutions described in Examples 1 and 2 above and for a comparative example that is generally typical of current commercial stripper solutions.

TABLE II

| | | Wafers | |
|---|---|---|---|
| | | Stripped | Resist |
| Stripping | | with 20 L | Loading |
| Formu- | | of Stripper | Capacity |
| lation | Composition | Solution | cm³/L |
| From | 85.5 g DMSO | 150 × 200 mm | 18.8 |
| Example | 6 g Diethylene glycol | wafers with 80 | |
| 1 | monomethyl ether | μm photoresist | |
| | 2.7 g Aminoethylethanol- | | |
| | amine | | |
| | 2.75 g Tetramethylammo- | | |
| | nium hydroxide | | |
| | 2.75 g water | | |
| | 0.03 g DuPont FSO | | |
| | surfactant | | |
| From | 61 g DMSO | 200 × 300 mm | 84.8 |
| Example | 35 g Monoethanolamine | wafers with 120 | |
| 2 | 2 g Tetramethylammonium | μm photoresist | |
| | hydroxide | | |
| | 2 g water | | |
| | 0.03 g DuPont FSO | | |
| | surfactant | | |
| Compar- | 74 g n-methylpyrrolidone | 25 × 300 mm | 10.6 |
| ative | 24 g 1,2-propanediol | wafers with 120 | |
| Example | 1 g Tetramethylammonium | μm photoresist | |
| | hydroxide | | |
| | 1 g water | | |

### EXAMPLE 17

Dimethylsulfoxide (85.5 g), diethylene glycol monomethyl ether (6.0 g), aminoethylethanolamine (2.7 g) and tetramethylammonium hydroxide (TMAH) pentahydrate (5.5 g) were combined to provide a stripper solution containing about 3 wt. % water and a dryness coefficient of about 0.9. Dissolution of the hydroxide pentahydrate was facilitated by slightly agitating the mixture. The about 3 wt. % water in the solution came substantially from the pentahydrate.

### EXAMPLE 18

Active 3A molecular sieves were added to three different samples of the stripper solution prepared according to the method of Example 17 and maintained in contact with the stripper solutions for 72 hours at ambient temperature. The sieves were removed by filtration and the moisture content of the initial and dried solutions determined by the Karl Fischer method. The dried stripper solutions were stored in closed container. The spent sieves could be dried for reuse or disposed of. The specific details for this experiment are tabulated below in Table III.

TABLE III

| | Stripper | | | |
|---|---|---|---|---|
| | Solution | | % Water | Dryness |
| Example | (g) | Sieves (g) | Remaining | Coefficient |
| 18 (a) | 11.4 | 15.16 | 2.37 | 1.13 |
| 18 (b) | 126.4 | 25 | 1.36 | 1.99 |
| 18 (c) | 135.48 | 45.25 | 0.78 | 3.46 |

Varying amounts of calcium hydride, as well as other solid desiccants can be substituted for molecular sieves in this example to provide stripper solutions having similarly reduced levels of water.

### EXAMPLE 19

Three silicon wafers having a negative acrylate polymer-based dry film photoresist (120 μm) placed thereon over a copper region were separately immersed in the three dried stripper solutions prepared in Example 18 and maintained at 70° C. for 60 minutes. The samples were removed and rinsed with deionized water for one minute. The resulting stripper solutions were analyzed for the number of particles of photoresist suspended therein utilizing a LiQuilaz SO5 particle analyzer and the copper etch rate determined for each wafer. The results are tabulated in Table IV provided below. LiQuilaz is a registered trademark of Particle Measuring Systems, Inc., 5475 Airport Blvd., Boulder, Colo., 80301.

TABLE IV

| | | | Mass of | Particles/g | |
|---|---|---|---|---|---|
| Stripper | Stripper | Number of | Removed | photoresist | Copper |
| Solution | Solution | Suspended | Photoresist | removed/g | Etch Rate |
| Source | (g) | Particles | (g) | solution | Å/minute |
| 18 (a) | 114.5 | 12444.4 | 0.2428 | 447.63 | <1.0 |
| 18 (b) | 126.4 | 9088.4 | 0.2914 | 246.74 | <1.0 |
| 18 (c) | 135.8 | 186.8 | 0.2523 | 5.46 | <1.0 |

Photoresist removal as described above can be carried out at temperatures ranging from about 70° C. to about 80° C. without taking any measures to exclude moisture. However, when photoresist removal is carried out at lower temperatures, of less than about 70° C., it may be helpful to take measures to minimize the uptake of moisture from the atmosphere. Providing a blanket of dry nitrogen over the stripper solution maintained at less than about 70° C. has proven effective to minimize water uptake by the stripper solution with longer exposures to a moist atmosphere. The ability of the dry stripper solutions described above to dissolve larger amounts of photoresists and minimize the number of particles dispersed in the stripper solutions extends the stripper solutions effective lifetime and reduces overall costs.

### EXAMPLE 20

A 25 wt % solution of tetramethylammonium hydroxide pentahydrate in methanol was prepared and 40.8 grams of the solution was warmed to about 30° C. in a water bath and maintained at a pressure of about 0.01 mmhg for about 75 minutes. Condensate was collected in a Dewar flask cooled with liquid nitrogen. After about 75 minutes, the temperature of the water bath was raised to about 35° C. and maintained at that temperature for an additional 105 minutes. A white paste resulted. The vacuum was broken and 85.8 g of dry DMSO was added to dissolve the white solid after which were added 6.0 g of diethylene glycol monomethyl ether and 2.7 g of aminoethylethanolamine to provide a substantially dry version of the stripper solution described in Example 1, Table I. The dry stripper solution's water content was found to be 0.71% by the Karl Fischer method and the solution contained less than 1% methanol. Lower levels of water can be obtained by adding additional methanol to the white paste and maintaining the resulting solution at reduced pressure for an additional 2 to 5 hours.

### EXAMPLE 21

Appropriate quantities of dry stripper solutions of the type described in Example 18 are packaged with active molecular sieves to maintain the stripper solutions in a dry condition for longer periods of time. About 5 to about 10 grams of active sieves are added for each 100 g of stripper solution maintained in a closed and sealed container. Molecular sieves in the form of pellets are preferred. However, powdered sieves can be used if removed by filtration prior to use or if small amounts of particulate matter do not interfere with use of the dry stripper solution.

### EXAMPLE 22

### Immersion Cleaning

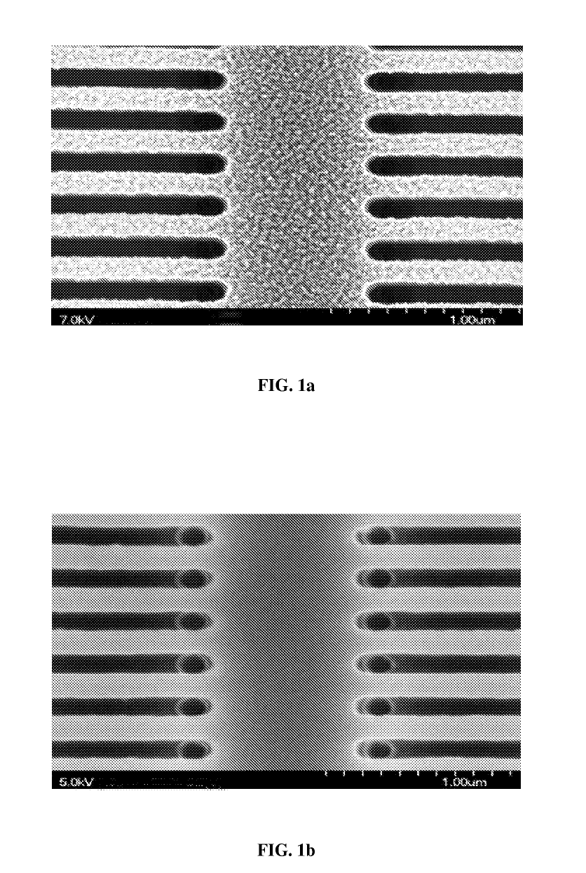

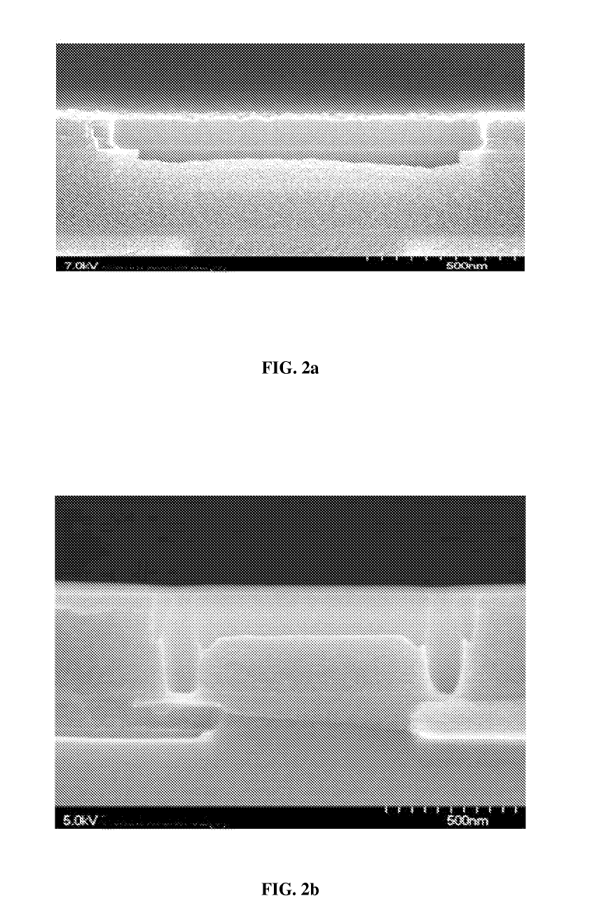

A silicon wafer was selected having a via fabricated in a low k dielectric overlaid with a silicon-containing bilayer. The bilayer included a base layer resist having a thickness of about 400 nm covered by a Si-enriched 193 nm imageable resist having a thickness of about 250 nm. See FIGS. 1a and 2a for SEM images of the wafer selected prior to cleaning. The wafer was immersed in the stripping solution from Example 1 and maintained at a temperature of about 80° C. for about 10 minutes. The wafer was removed, rinsed with DI water and dried. Examination of the wafer demonstrated removal of all of the bilayer resist from the wafer's surface and from the via, leaving an intact dielectric, and an unaffected capping layer. See FIGS. 1b and 2b for SEM images of the wafer after cleaning.

### EXAMPLE 23

### Cleaning with Single Wafer Spray Tool

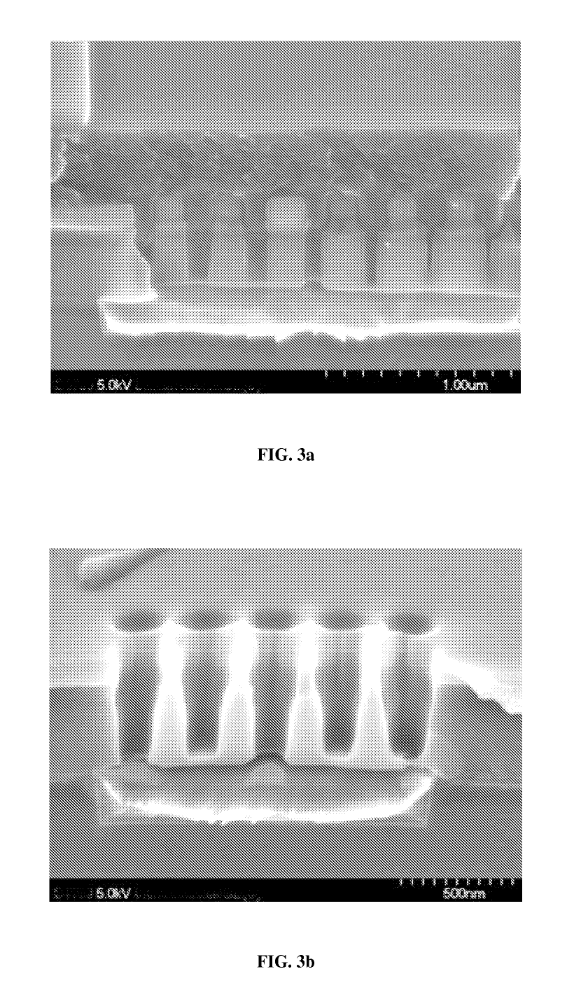

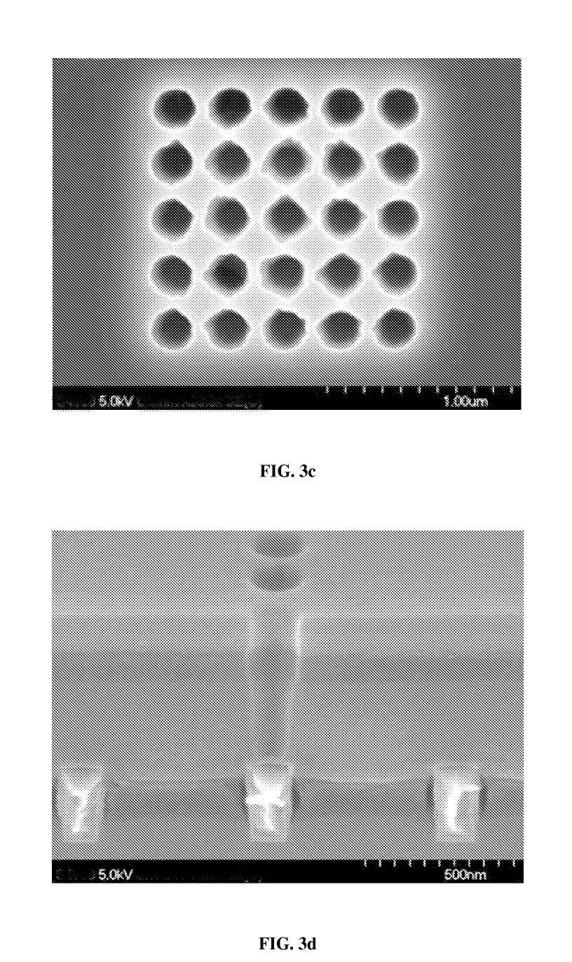

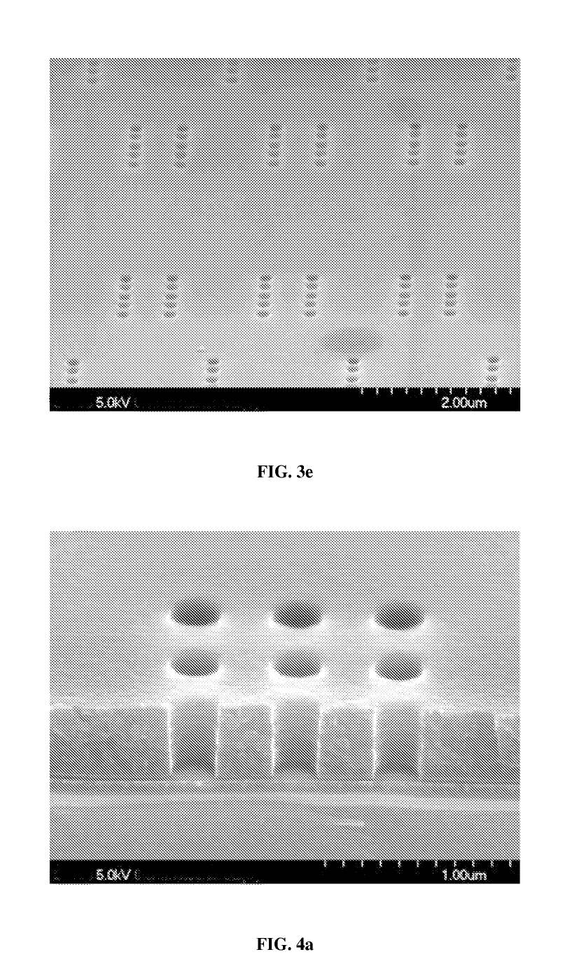

A silicon wafer was selected, the wafer having a via fabricated in a low k dielectric with a silicon-containing bilayer resist. The bilayer resist included a base layer covered by a Si-enriched 193 nm imageable resist. See FIG. 2a for an SEM image of the wafer selected prior to cleaning. A stripper solution was selected that included 65% DMSO, 25% monoethanolamine, 5% TMAH, and 5% water. The coated wafer was cleaned using a single wafer spray tool utilizing a 4 step process. The steps included contacting the wafer with a warm spray of the stripper solution, removing excess stripper solution from the wafer surface, rinsing, and drying. Table V below illustrates typical parameters for utilizing a single batch spray tool to remove a bilayer resist utilizing a stripper maintained at about 80° C. Inspection of the cleaned wafer demonstrated that the bilayer resist had been completely removed without damaging the dielectrics. See FIG. 3b for an SEM image of the wafer after cleaning for two (2) minutes. Even when the spray time was extended to 5 minutes at 80° C., no damage was observed to any of the wafer's dielectrics. See FIG. 3d for an SEM image of the wafer after cleaning for five (5) minutes.

TABLE V

| | | Chuck | | | | |
|---|---|---|---|---|---|---|
| | | speed | Time | Flow | | |
| Step | Medium | (rpm) | (sec) | (Lpm) | Boom swing* | |
| 1 | Stripper | 400 | 120 | 1.2 | +/−15@0; | +/−10@60 |
| 2 | none | 500 | 3 | na | +/−5@0; | 30@0 |
| 3 | DI | 300 | 30 | 1.5 | +/−15@0; | +/−10@25 |
| | water | | | | | |
| 4 | N₂ | 1000 | 4× | 20 | −35 + 10@0; | −34 + 9@0 |

*Boom swing gives the dispensing profile and is reported as (speed)@(Position from center) where center position is defined as “0.”

### EXAMPLE 24

### Cleaning with Single Wafer Spray Tool

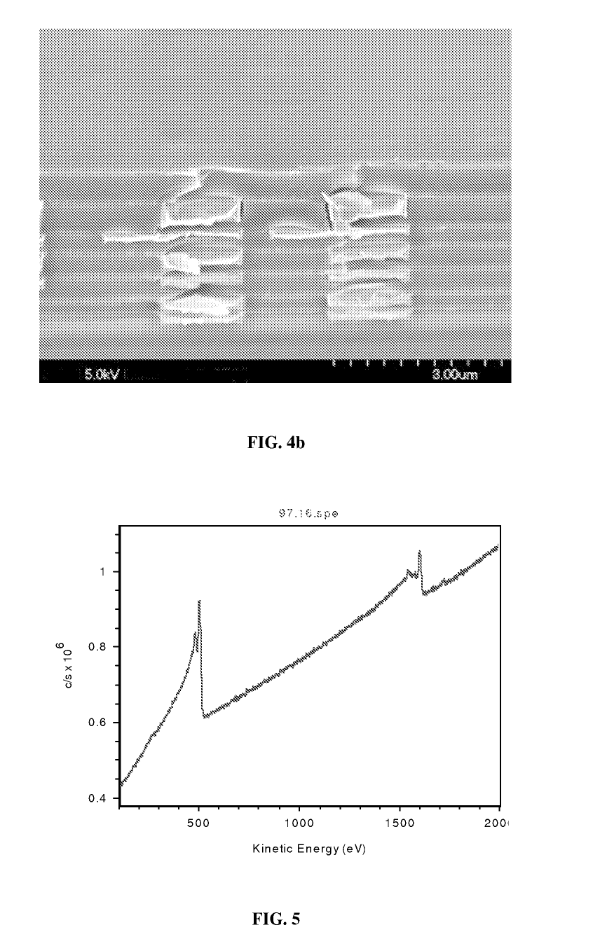

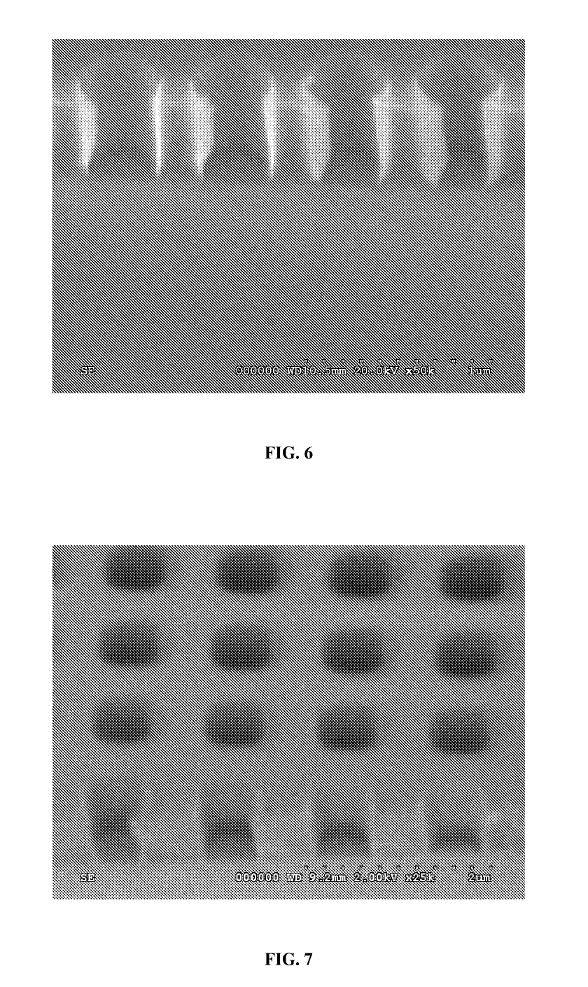

A silicon wafer was selected, the wafer having a 400 nm trench and a 90 nm via fabricated in a low k dielectric with a silicon-containing trilayer resist. The trilayer resist included a silicon containing planarizing layer, an inorganic hard mask and a photoresist. See FIG. 4a for an SEM image of the wafer selected prior to cleaning. A stripper solution was selected that included 65% DMSO, 25% monoethanolamine, 5% TMAH, and 5% water. The coated wafer was cleaned using a single wafer spray tool utilizing the general 4 step process described in Example 23. Table VI, below, illustrates the experimental parameters utilized to remove the trilayer resist. Inspection of the cleaned wafer demonstrated that the trilayer resist had been completely removed without damaging the dielectrics. See FIG. 4b for an SEM image of the wafer after cleaning. Further analysis with Auger Electron Spectroscopy after sputtering for 0.6 of a minute to remove adventitious carbon confirmed removal of all resist material from the wafer and dielectric material. See FIG. 5 for an Auger Electron Spectrum of the cleaned wafer.

TABLE VI

| | | Chuck | | | | |
|---|---|---|---|---|---|---|
| | | speed | Time | Flow | | |
| Step | Medium | (rpm) | (sec) | (Lpm) | Boom swing* | |
| 1 | Stripper | 400 | 600 | 1.2 | +/−15@0; | +/−10@60 |
| 2 | none | 500 | 3 | na | +/−5@0; | 30@0 |
| 3 | DI | 300 | 30 | 1.5 | +/−15@0; | +/−10@25 |
| | water | | | | | |
| 4 | N₂ | 1000 | 4× | 20 | −35 + 10@0; | −34 + 9@0 |

*Boom swing gives the dispensing profile and is reported as (speed)@(Position from center) where center position is defined as “0.”

### EXAMPLE 25

### Cleaning with Batch Spray Tool

Silicon wafers were selected having a microstructure including a plurality of vias fabricated in a low k dielectric. An antireflective coating was applied to each the wafers' surface by spinning onto the wafer a solution containing a novolac based polymer, an ionic acid catalyst and a urea-based cross linker and curing the coated wafers at about 155° C. The coated wafers were cleaned in a batch spray solvent tool in the following manner with a stripper solution containing 65% DMSO, 25% monoethanolamine, 5% TMAH, and 5% water. The wafers were contacted with a spray of the stripper solution maintained at about 60° C. for about 2 minutes at a spin rate of about 50 rpm. The lines were purged with nitrogen for about 7 seconds and the wafers rinsed with DI water at ambient temperature for about 30 seconds without spinning. Again the lines were purged with nitrogen for about 7 seconds followed by three successive rinses with DI water at ambient temperature; 1 minute at 50 rpm, 1 minute at 500 rpm, and 2 minutes at 50 rpm. The drain lines were then allowed to drain for about 10 seconds and the lines again purged with nitrogen for about 10 seconds. The wafers were finally subjected to nitrogen gas for 1 minute at 1200 rpm and for 8 minutes at 600 rpm. The resulting dry wafers were inspected for removal of the antireflective coating and for damage to the dielectric material and the underlying wafer. All antireflective coating was removed and no damage was discerned for the dielectric material and underlying wafer. See FIG. 6 for an SEM image of the wafer after cleaning.

### EXAMPLE 26

### Cleaning with Batch Spray Tool

Silicon wafers were selected having a microstructure including a plurality of vias fabricated in a low k dielectric. An antireflective coating was applied to each the wafers' surfaces by spinning onto the wafer a solution containing a novolac based polymer, an ionic acid catalyst and a urea-based cross linker and curing the resulting wafers at about 135° C. The coated wafers were cleaned in a batch spray solvent tool in the following manner with a stripper solution containing 65% DMSO, 25% monoethanolamine, 5% TMAH, and 5% water. The wafers were contacted with a spray of the stripper solution maintained at about 65° C. for about 1 minute at a spin rate of about 50 rpm. The lines were purged with nitrogen for about 7 seconds and the wafers rinsed with DI water at ambient temperature for about 30 seconds without spinning. Again the lines were purged with nitrogen for about 7 seconds followed by three successive rinses with DI water at ambient temperature; 1 minute at 50 rpm, 1 minute at 500 rpm, and 2 minutes at 50 rpm. The drain lines were allowed to drain for about 10 seconds, the lines again purged with nitrogen for about 10 seconds and the wafers were subjected to nitrogen gas for 1 minute at 1200 rpm and for 8 minutes at 600 rpm. The resulting dry wafers were inspected for removal of the antireflective coating and for damage to the dielectric material and the underlying wafer. All antireflective coating was removed and no damage was discerned for the dielectric material and underlying wafer. See FIG. 7 for an SEM image of the wafer after cleaning.

### EXAMPLE 27

### Cleaning with Batch Spray Tool

Silicon wafers were selected having a via fabricated in a low k dielectric overlaid with a silicon-containing bilayer resist. The bilayer resists included a base layer resist having a thickness of about 400 nm covered by a Si-enriched 193-nm imageable resist having a thickness of about 250 nm. The coated wafers were cleaned in a batch spray solvent tool in the following manner with a stripper solution containing 65% DMSO, 25% monoethanolamine, 5% TMAH, and 5% water. The wafers were contacted with a spray of the stripper solution maintained at about 65° C. for about 1 minute at a spin rate of about 50 rpm. The lines were purged with nitrogen for about 7 seconds and the wafers rinsed with DI water at ambient temperature for about 30 seconds without spinning. Again the lines were purged with nitrogen for about 7 seconds followed by three successive rinses with DI water at ambient temperature; 1 minute at 50 rpm, 1 minute at 500 rpm, and 2 minutes at 50 rpm. The drain lines were allowed to drain for about 10 seconds, the lines were again purged with nitrogen for about 10 seconds and the wafers were subjected to nitrogen gas for 1 minute at 1200 rpm and for 8 minutes at 600 rpm. The resulting dry wafers were inspected for possible damage to any of the permanent wafer materials. All bilayer material had been removed from the wafer, including from the vias and no damage of any permanent part of any of the wafer materials was discerned.

### EXAMPLE 28

### Solution Compatibility with Low Dielectric Materials

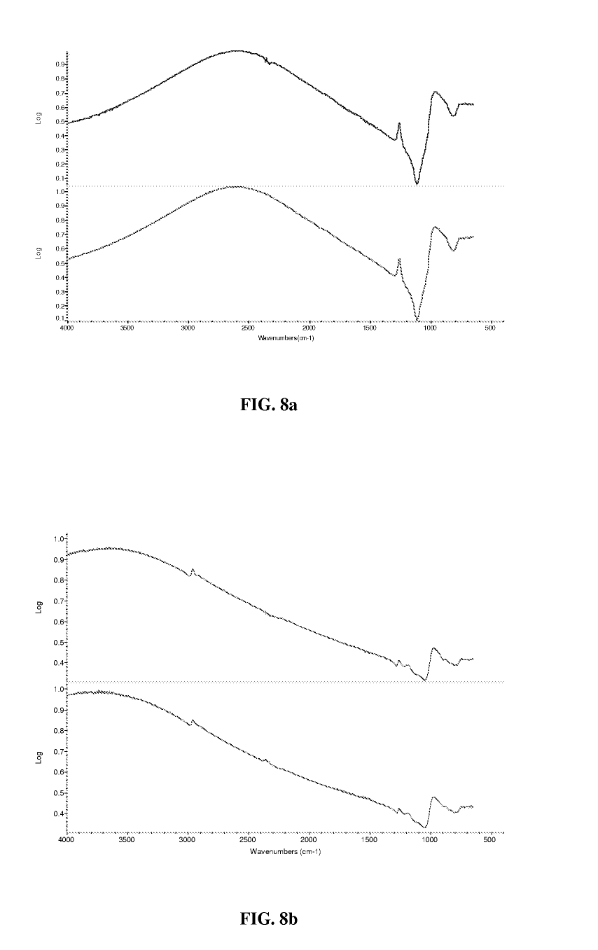

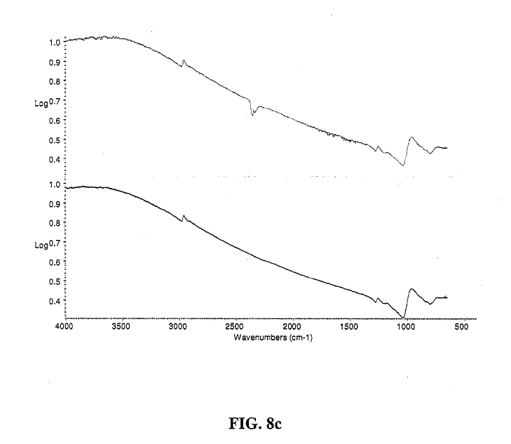

The thickness and chemical composition of three dielectric coatings (thermal oxide dielectric, CORAL® dielectric material, and BLACK DIAMOND® dielectric material) were examined by FTIR. Each coating was separately immersed in a stripper solution containing 65% DMSO, 25% monoethanolamine, 5% tetramethylammonium hydroxide (TMAH), and 5% water. Immersion of the coatings was carried out at 65° C. for about 30 minutes. Upon removal from the stripper solution the coatings were rinsed with DI water, dried and re-examined by FTIR. A broad hydroxyl band at about 3200 to 3600 cm⁻¹ and a decreased C—H stretch at about 3000 cm⁻¹ are signs of damage to the dielectric coating. These bands were not observed in the FTIR spectra for the coatings immersed in the stripper solution for as long as 6 to 30 times the normal cleaning time. Immersion of the coatings in the stripper solution resulted in no changes in coating thickness or chemical composition based on the FTIR spectra of the coatings illustrating the compatibility of the stripper solution with current dielectric materials. See FIGS. 8a, 8b, and 8c for the FTIR spectra of thermal oxide, CORAL® dielectric, and BLACK DIAMOND® dielectric, respectively. Thermal oxide is a silicon dioxide coating and both CORAL® and BLACK DIAMOND® dielectric materials are silicon oxides having organic moieties added to reduce the dielectric constant. CORAL is a registered trademark of Novellus Systems, Inc., 3970 North First Street, San Jose, Calif. 95134. BLACK DIAMOND is a registered trademark of Applied Materials, P.O Box 450A, Santa Clara, Calif. 95052.

### EXAMPLE 29

Silicon wafers were selected having a via fabricated in a low k dielectric overlaid with a silicon-containing bilayer. The bilayers included a base layer resist having a thickness of about 400 nm covered by a Si-enriched 193 nm imageable resist having a thickness of about 250 nm. The wafers were immersed in the different stripping solutions for periods of time as outlined in Table VII below. In each case the bilayer was removed without causing damage to the underlying substrate.

TABLE VII

| Formulation | Temperature ° C. | Time | |
|---|---|---|---|
| Stripper from Example 1 | 60 | 1 | min. |
| Stripper from Example 1 | 60 | 1 | min, 20 sec. |
| Stripper from Example 1 | 60 | 1 | min, 40 sec. |
| Stripper from Example 1 | 60 | 2 | min. |
| Stripper from Example 2 | 60 | 1 | min. |
| Stripper from Example 2 | 60 | 1 | min, 20 sec. |
| Stripper from Example 2 | 60 | 1 | min, 40 sec. |
| Stripper from Example 2 | 60 | 2 | min. |
| 61% DMSO, 33% | 65 | 10 | min |
| monoethanolamine, 3% | | | |
| TMAH, and 3% water | | | |
| 61% DMSO, 33% | 65 | 20 | min. |
| monoethanolamine, 3% | | | |
| TMAH, and 3% water | | | |
| 90% DMSO, 5% | 65 | 10 | |
| monoethanolamine, 2.5% | | | |
| TMAH, and 2.5% water | | | |
| 90% DMSO, 5% | 65 | 20 | |
| monoethanolamine, 2.5% | | | |
| TMAH, and 2.5% water | | | |

### EXAMPLE 30

### Dry Stripper Solutions Having Improved Performance

Silicon wafers were prepared having a via fabricated in a low k dielectric overlaid with a silicon-containing bilayer. The bilayer included a base layer resist having a thickness of about 400 nm covered by a Si-enriched 193 nm imageable resist having a thickness of about 250 nm. Silicon wafers were also prepared having an organic spin-on hard mask. Finally, silicon wafers were also prepared having a microstructure including a plurality of vias fabricated in a low k dielectric. An antireflective coating was applied to each the wafers' surface by spinning onto the wafer a solution containing a novolac based polymer, an ionic acid catalyst and a urea-based cross linker and curing the coated wafers at about 155° C.

Two stripper formulations were prepared. The first, Formulation A. contained 65% DMSO, 25% monoethanolamine, 5% TMAH, and 5% water. The second, Formulation B, contained 85.77% DMSO, 6.0% diethylene glycol methyl ether, 2.75% TMAH, 2.75% water, 2.7% aminoethylethanolamine, and 0.03% FSO surfactant. Both formulations were dried with molecular sieves. The dried first formulation contained 0.753% water whereas the dried second formulation contained 0.362% water. Wafers having bilayer resists, organic spin-on hard masks, and antireflective coatings were immersed in heated solutions of the dry strippers long enough for complete removal of the coatings. The immersion conditions and time required for removal of the coatings are summarized in Table VIII below.

TABLE VIII

| | | | | | Dryness |
|---|---|---|---|---|---|
| Formulation | Coating | Temperature, ° C. | Time | | Coefficient |
| A | bilayer resist | 65 | 1 | min. | 6.6 |
| A | hard mask | 65 | 30 | sec. | 6.6 |
| A | antireflective | 65 | 6 | min. | 6.6 |
| | coating | | | | |
| B | bilayer resist | 65 | 1 | min. | 7.6 |
| B | hard mask | 65 | 1 | min. | 7.6 |
| B | antireflective | 65 | 6 | min. | 7.6 |
| | coating | | | | |

While applicant's disclosure has been provided with reference to specific embodiments above, it will be understood that modifications and alterations in the embodiments disclosed may be made by those practiced in the art without departing from the spirit and scope of the invention. All such modifications and alterations are intended to be covered.

What is claimed is:

1. A solution method for preparing an electronic interconnect structure comprising:
(a) selecting a substrate having a plurality of resist layers thereon;
(b) contacting the substrate with a stripper solution for a time sufficient to remove said plurality of resist layers; wherein the stripper solution: (i) comprises dimethyl sulfoxide, a quaternary ammonium hydroxide, and an alkanolamine having at least two carbon atoms, at least one amino substituent and at least one hydroxyl substituent, the amino and hydroxyl substituents attached to different carbon atoms.

2. The method of claim 1, wherein the method further comprises the step of rinsing said stripper solution from said substrate with a solvent.

3. The method of claim 1, wherein said rinsing involves rinsing said substrate with a solvent selected from the group consisting of water, and a lower alcohol.

4. The method of claim 3, wherein said rinsing involves rinsing with water and said water is DI water.

5. The method of claim 3, wherein said rinsing involves rinsing with a lower alcohol and said lower alcohol is isopropanol.

6. The method of claim 1, wherein said selecting involves selecting a substrate having at least three resist layers.

7. The method of claim 1, wherein said contacting involves contacting said substrate with a stripper solution further comprising a secondary solvent.

8. The method of claim 7, wherein said contacting involves contacting said substrate with a stripper solution, wherein said secondary solvent is a glycol ether.

9. The method of claim 8, wherein said contacting involves contacting said substrate with a stripper solution, wherein said glycol ether is diethylene glycol monomethyl ether.

10. The method of claim 6, wherein said contacting involves contacting said substrate with said stripper solution including a substituted quaternary ammonium hydroxide wherein said substituted quaternary ammonium hydroxide has substitutents that are (C₁-C₈)alkyl, arylalkyl or combinations thereof.

11. The method of claim 6, wherein said contacting involves contacting said substrate with said stripper solution including from about 20% to about 90% dimethyl sulfoxide; from about 1% to about 7% quaternary ammonium hydroxide; from about 1% to about 75% alkanolamine.

12. The method of claim 6, wherein said contacting involves contacting said substrate with said stripper solution including said alkanolamine having the formula: 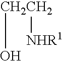
where R¹ is H, (C₁-C₄) alkyl, or (C₁-C₄) alkylamino.

13. The method of claim 12, wherein said contacting involves contacting said substrate with said stripper solution including said alkanolamine wherein R¹ is CH₂CH₂NH₂.

14. The method of claim 1, wherein said contacting involves contacting said substrate with said stripper solution at a temperature ranging from about 50° C. to about 85° C.

15. The method of claim 14, wherein said contacting involves immersing said substrate in said stripper solution.

16. The method of claim 14, wherein said contacting involves spraying said stripper solution onto the substrate.

17. The method of claim 16, wherein said spraying involves spraying a single substrate at a time.

18. The method of claim 16, wherein said spraying involves spraying a plurality of substrates at the same time.

19. The method of claim 1, wherein said contacting involves contacting said substrate with said stripper solution under a blanket of nitrogen.

20. The method of claim 1, wherein said contacting involves contacting said substrate with said stripper solution having a dryness coefficient (DC) of at least about 1, where said dryness coefficient is defined by the equation:
$$DC = \frac{mass of base / mass of solution tested}{mass of water / mass of solution tested}$$

21. The method of claim 20, wherein said method further comprises the step of rinsing the stripper solution from the substrate with a solvent.

22. The method of claim 21, wherein said rinsing involves rinsing the substrate with a solvent selected from the group consisting of water, and a lower alcohol.

23. The method of claim 21 wherein said rinsing involves rinsing with water and said water is DI water.

24. The method of claim 22, wherein said rinsing involves rinsing with a lower alcohol and said lower alcohol is isopropanol.

25. The method of claim 20, wherein said selecting involves selecting a substrate having at least three resist layers.

26. The method of claim 20, wherein said contacting involves contacting said substrate with a stripper solution further comprising a secondary solvent.

27. The method of claim 26, wherein said contacting involves contacting said substrate with a stripper solution, wherein said secondary solvent is a glycol ether.

28. The method of claim 27, wherein said contacting involves contacting said substrate with a stripper solution, wherein said glycol ether is diethylene glycol monomethyl ether.

29. The method of claim 20, wherein said contacting involves contacting said substrate with said stripper solution including a substituted quaternary ammonium hydroxide wherein said substituted quaternary ammonium hydroxide has substitutents that are (C₁-C₈)alkyl, arylalkyl or combinations thereof.

30. The method of claim 29, wherein the dimethyl sulfoxide comprises from about 20% to about 90% of the composition; the quaternary ammonium hydroxide comprises from about 1% to about7% of the composition; the alkanolamine comprises from about 1% to about 75% of the composition.

31. The method of claim 20, wherein said contacting involves contacting said substrate with said stripper solution including said alkanolamine having the formula: 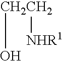
where R¹ is H, (C₁-C₄) alkyl, or (C₁-C₄) alkylamino.

32. The method of claim 31, wherein said contacting involves contacting said substrate with said stripper solution including said alkanolamine wherein R¹ is CH₂CH₂NH₂.

33. The method of claim 20, wherein said contacting involves contacting said substrate with said stripper solution at a temperature ranging from about 50° C. to about 85° C.

34. The method of claim 33, wherein said contacting involves immersing said substrate in said stripper solution.

35. The method of claim 33, wherein said contacting involves spraying said stripper solution onto the substrate.

36. The method of claim 35 wherein said spraying involves spraying a single substrate at a time.

37. The method of claim 34 wherein the spraying involves spraying a plurality of substrates at the same time.

38. The method of claim 20, wherein said contacting involves contacting said substrate with said stripper solution under a blanket of nitrogen.

39. An electronic interconnect structure prepared according to claim 1.
